(19) United States
(12) Patent Application Publication
(10) Pub. No.: US 2014/0243102 A1
(43) Pub. Date: Aug. 28, 2014

(54) SYSTEM AND METHODS FOR TELE-INTERACTIVE PLAY ITEMS

(71) Applicant: R2Z Innovations, Inc., Vancouver (CA)

(72) Inventors: Wolfgang Richter, Dortmund (DE); Faranak Zadeh, Vancouver (CA)

(73) Assignee: R2Z INNOVATIONS, INC., Vancouver (CA)

(21) Appl. No.: 13/779,767

(22) Filed: Feb. 28, 2013

(51) Int. Cl. A63F 13/00

(52) U.S. Cl. CPC A63F 13/00
USPC 463/43

(57) ABSTRACT

An interactive gaming system for a user is provided. The interactive gaming system includes a one or more play items, a function control unit and a personal assistant portal. The one or more play items releases one or more action signals of the user under the influence of alternating electrical field produced from the function control unit. The function control unit receives the action signals from the user and then further transmits the one or more action signals to the personal assistant portal through an input server. The personal assistant portal processes and transmits the one or more action signals received from the function control unit to the one or more feedback unit. The feedback unit further plays the action signals received from the personal assistant portal.

### CROSS-REFERENCE OF RELATED APPLICATION

This application is a continuation-in-part application of a U.S. patent application Ser. No. 13/156,339 filed on Jun. 9, 2011 which is currently co-pending. The application Ser. No. 13/156,339 further claims priority to U.S. Provisional Application No. 61/353,463 filed on Jun. 10, 2010, the entire contents of which are incorporated herein by references.

### BACKGROUND OF THE INVENTION

1. Field of Invention

The present invention generally relates to interactive toy systems, and more particularly relates to interactive play items influenced and operated under electric field.

2. Description of Related Art

Various self-propelled mobile robots have been known in the art. With the partial exception of industrial automation for highly repetitive situations, educational purposes, and toys, mobile robots are not widely used. This is because the problems of coping with machine vision, artificial intelligence, general purpose robotic “arm” and “hand” like actuation systems, limited battery life, and the like make it difficult to devise flexible and general purpose systems suitable for widespread use. These systems have used a variety of different techniques to achieve interactive conversation, and have ordinarily had limited success at conversations which were more than mere simple question and answer sessions.

U.S. Pat. No. 4,964,062 which teaches a type of robotic arm that may be controlled by radio from a remote location, and may be programmed by radio from a remote location. U.S. Pat. Nos. 5,231,693 and 5,046,022 describe methods of semi-automating tele-robotic control.

Various conventional devices have now become bored and required ones with new effects. There has been a loss of billions USD to the toy industry and therefore, there is a requirement of new interactive toys where users may create virtual worlds and could express their fantasies and control game consoles.

### SUMMARY OF THE INVENTION

In accordance with the teachings of the present invention, a system and method for tele-interactive gaming, is provided.

An object of the present invention is to provide a system and method for tele-interactive gaming with one or more play items to release action signals, a function control unit to receive action signals and a personal assistant portal to broadcast the action signals and further being displayed by a feedback unit. The one or more play items are under the influence of electric field produced by the function control unit.

Another object of the present invention is to provide a system and method for tele-interactive gaming with the indexing of functional control unit and the personal assistant portal. The indexing allows the function control unit to be recognized by the personal assistant portal.

Another object of the present invention is to provide the personal assistant portal with a user bank to store user details, a job bank to store instructions of the gaming and virtual personal assistant software to transmit information stored in the job bank and the user bank.

Another object of the present invention is to provide a function control unit with a generator, a convertor, one or more sensors, a s2f box and an interface.

Another object of the present invention is to provide one or more play items with action sensors that respond to the movement of the user actions.

### BRIEF DESCRIPTION OF DRAWINGS

FIG. 1 illustrates a block diagram of an interactive gaming system in accordance with an embodiment of the present invention;

FIG. 2 illustrates a block diagram of an interactive gaming system in accordance with another embodiment of the present invention;

FIG. 3 illustrates a perspective view of a play item, in accordance with an embodiment of the present invention; and

FIG. 4 illustrates a table for describing one or more commands provided by virtual personal assistant software in accordance with an embodiment of the present invention.

### DETAILED DESCRIPTION OF DRAWINGS

While this technology is illustrated and described in a preferred embodiment, electronic-supported game system may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

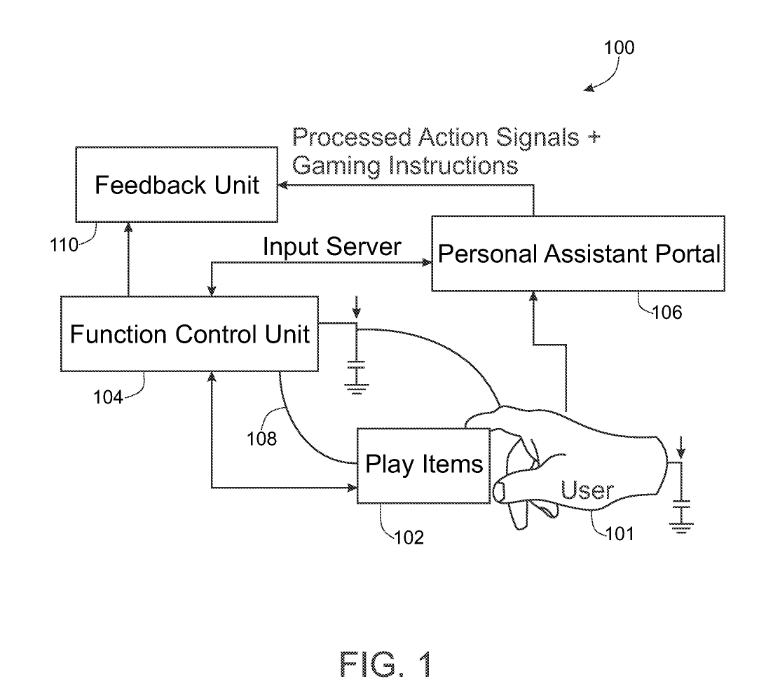

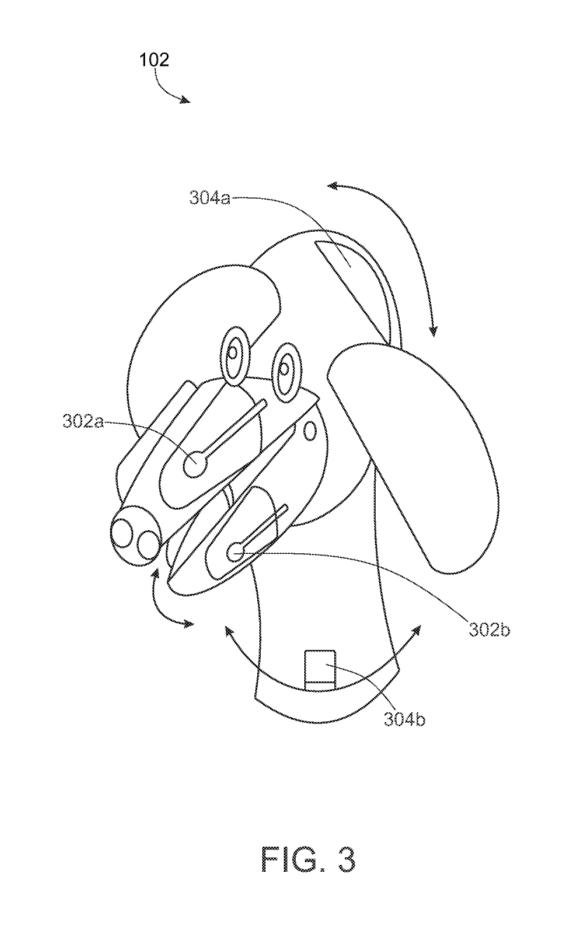

FIG. 1 illustrates a block diagram of interactive gaming system 100 for a user 101. The interactive gaming system 100 includes one or more play items 102, a function control unit 104 and a personal assistant portal 106. The one or more play items 102 release one or more action signals of the user 101. The one or more play items 102 and one or more action signals are explained in detailed in conjunction with FIG. 3 of the present invention.

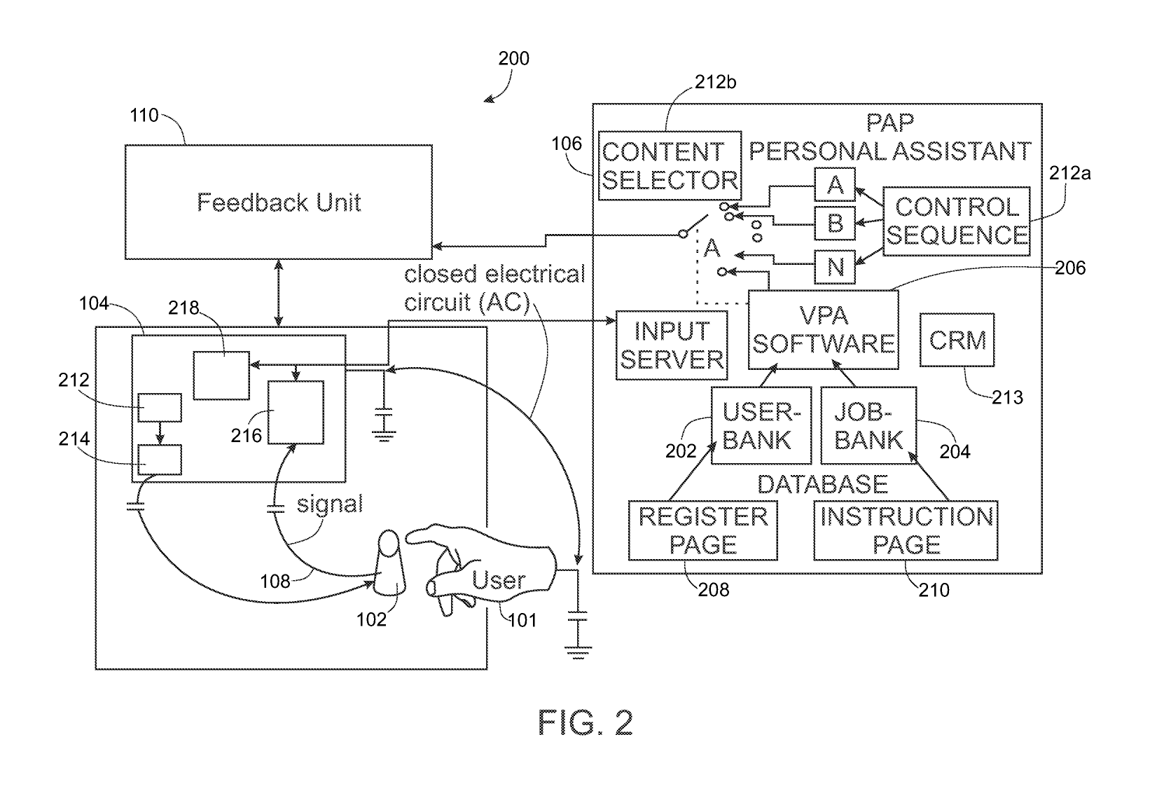

The function control unit 104 receives the one or more action signals released from the one or more play items 102. The function control unit 104 further sends the one or more action signals to the personal assistant portal 106 through an input server. The function control unit 104 releases alternating electric field 108 to influence one or more play items 102 for releasing one or more action signals. The function control unit 104 is explained in detailed in conjunction with FIG. 2 of the present invention.

The personal assistant portal 106 stores gaming instructions and user information. The gaming instructions and user information is explained in detailed in conjunction with FIG. 2 of the present invention. The personal assistant portal 106 further process and then transmits the action said one or more action signals and gaming instructions to one or more feedback unit 110 of said user 101. The one or more feedback unit 110 plays the processed one or more action signals received from the personal assistant portal. Examples of feedback unit 110 includes but not limited to Set-top Box, visual display device, audio device (Radio) or audio-visual device such as TV, LED, LCD etc. The function control unit 104 is direct or wirelessly connected to at least one input server, using networks like the internet.

FIG. 2 illustrates a block diagram of an interactive gaming system 200 in accordance with another preferred embodiment of the present invention. The personal assistant portal 106 includes a user bank 202 for storing details of the user 101, a job bank 204 for storing instructions of gaming and a virtual personal assistant software 206 connected to the user bank 202 and the job bank 204. The virtual personal assistant software 206 further processes and then transmits the information stored in the user bank 202 and the job bank 204. The information related to job bank 204 and user bank 202 is then played by the one or more feedback unit 110.

In another preferred embodiment of the present invention, the user bank 202 includes a register page 208 for allowing registration of one or more users 101. The job bank 204 includes an instruction page 210 which allows an operator to create or store game and contend related action scripts, called jobs. The registration page 208 allows the user 101 to fill details such as name, age, date of birth, country, marital status, preferences etc. The instruction page 210 allows entering commands or information such as game instructions, time codes, networks or content links, calculations, statements etc.

In another preferred embodiment of the present invention, the virtual personal assistant software 206 is connected to control sequences 212a and content selector 212b to select the content to be played on the one or more feedback unit 110. In a preferred embodiment of the present invention as shown in the FIG. 2, A, B, . . . N indicates various control sequences 212a and a control sequence A is selected by the content selector 212b and is further transmitted to the one or more feedback unit 110, which plays the content.

In another embodiment of the present invention, the personal assistant portal 106 further includes a customer relationship management module 213 for maintaining the records of the activities of the user 101.

In a preferred embodiment of the present invention, the function control unit 104 includes a generator 214 for generating a frequency, a convertor 215 for converting the frequency into alternating electric field 108, one or more sensors 216 for detecting the one or more action signals received from the one or more play items 102 and an interface 218 connected to the one or more feedback 110. The interface 218 transmits the one or more action signals to the virtual personal assistant software 206 through the input server 220. The one or more action signal is explained in detailed in conjunction with FIG. 3 of the present invention.

In another preferred embodiment of the present invention, the personal assistant portal 106 provide gaming instructions from the job bank 204 to the feedback unit to display set of instructions for the play item 102. The user 101 has to follow said instructions by acting with the play item. For example, the user 101 can approach or touch a play item at a specific position. The user also can perform game related gestures close to the play item 102.

In another embodiment of the present invention, the play items 106 may further be controlled directly by the personal assistant portal 106. With reference to FIG. 2, the personal assistant portal 106 may directly control the one or more play items 102 through the electric field, provided by the said function control unit 104. The function control unit 104 further includes a S2F box (not shown in Figures) for receiving the processed one or more action signals and further transmitting function signals through the alternating electric field to said one or more play items 102.

FIG. 3 illustrates a perspective view of a play item 102, in accordance with a preferred embodiment of the present invention. The play item 102 includes a one or more action sensors 302 such as 302a and 302b. Under the influence of alternating electric field produced from the convertor the one or more action sensors 302 detects the user's action 101 and further produces one or more action signals. The play items 102 further includes one or more actors 304, such as 304a and 304b for performing electromechanical movements such as vertical and horizontal or other movements on electromechanical parts or perform audio-visual user attraction respectively.

In an exemplary embodiment, the play item 102 is a dog. If under the influence of electric field, the user moves the hand in the right direction near to the dog, then action sensors 302 and actors 304 in the dog react to the movement of the hand.

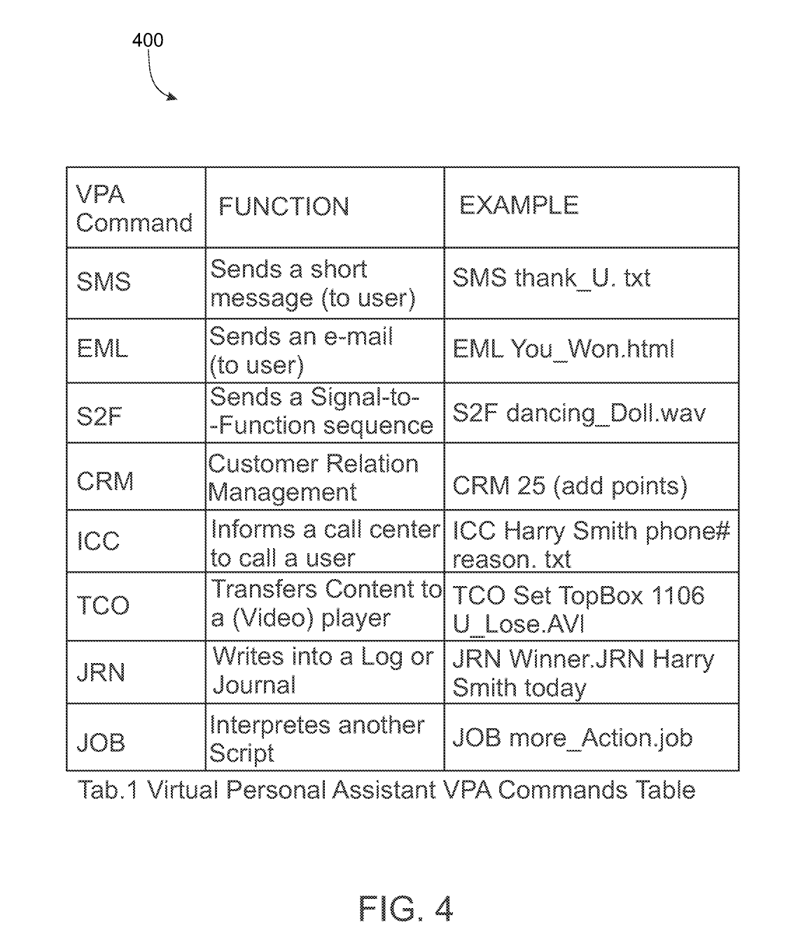

FIG. 4 illustrates a table 400 for describing one or more commands provided by virtual personal assistant software in accordance with an embodiment of the present invention. In a preferred embodiment, the virtual personal assistant software sends one or more commands to the one or more feedback unit or said function control unit or over the internet. As described in the table for exemplary purposes, following commands are provided by the virtual personal assistant software:

SMS command for sending short messages to the user via internet. An example of the command may be SMS thank_U.txt. EML command sends an email to the user via internet. An example of the command may be EML You_Won.html. S2F command sends signal to function sequence to the S2F box of the function control unit. An example of the command may be S2F dancing_doll.wav. This will make the doll (play item) to dance as per instructions. CRM command maintains activities of the user while playing a game. The command will be given to the user bank. An example of the command may be CRM 25 (add points). ICC command informs a call center to call a user. The call center may be informed either through SMS or email. An example of the command may be ICC Harry Smith phone#reason.txt. TCO command transfers content to a feedback unit such as video player. An example of the command may be TCO Set-Top box 1106 U_Lose.AVI. JRN command writes into a log or journal via internet. An example of the command may be JRN Winner.JRN Harry Smith today. JOB command interprets another script from the job bank. An example of the command may be JOB more_action.job.

In another embodiment of the present invention, the one or more play items are placed on the touch screen of a computing device. The computing device to process the action signals released from the one or more play items. The one or more play items plays the processed action signals on the one or more feedback unit. Examples of computing device includes but not limited to smartphones, IPAD, notebook etc.

However, it is to be understood that the foregoing commands are for exemplary purpose and any person skilled in the art would appreciate that similar commands may be also be produced without deviating from the scope of the present invention.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention. Furthermore, equivalents and modifications not described above may also be employed without departing from the scope of the invention, which is defined in the accompanying claims.

1. An interactive gaming system for a user, comprising:
one or more play items operative to release one or more action signals of said user;
a function control unit operative to receive said one or more action signals of said user, said function control unit further releases said one or more action signals to an input server; and
a personal assistant portal operative to store gaming instructions and user information, such that said personal assistant portal is operative to process and transmit both: said one or more action signals received from said input server; and gaming instructions to a one or more feedback unit of said user; and
such that said one or more feedback unit is operative to play both, said processed one or more action signals and gaming instructions, received from said personal assistant portal; further such that said one or more play items releases said one or more action signals under the influence of an electric field generated from said function control unit.

2. The one or more play items according to claim 1, further comprising one or more action sensors operative to detect one or more said user's action.

3. The one or more play items according to claim 2, further comprising one or more actors modules operative for electromechanical movements.

4. The personal assistant portal according to claim 1, further comprising:
a user bank storage operative for storing details of said user;
a job bank storage operative for storing instructions of gaming; and
a virtual personal assistant software connected with said user bank and said job bank, said virtual personal assistant software operative to process and transmit information stored in said user bank and said job bank, said transmitted information played by said one or more feedback unit.

5. The function control unit according to claim 4, further comprising:
a generator operative for generating a frequency;
a convertor operative for converting the frequency into alternating electric field;
one or more sensors operative for detecting said one or more action signals; and
an interface operative to transmit said one or more action signals received from said one or more sensors to said virtual personal assistant software.

6. The one or more play items according to claim 1, to be controlled by said personal assistant portal.

7. The function control unit according to claim 1, further comprises a signal-to-function box for receiving said processed one or more action signals and transmitting function signals through alternating electric field to said one or more play items.

8. The interactive gaming system according to claim 1, wherein said virtual personal assistant software sends one or more commands to said one or more feedback unit or said function control unit or over the internet.

9. The user bank according to claim 4, further comprising a register page operative for allowing registration of users.

10. The job bank according to claim 4, further comprising an instruction page operative for entering either game related or user related or content related instructions.

11. The personal assistant portal according to claim 1, further includes a customer relationship management module operative to maintain the activities of said user.

12. An interactive gaming system for a user comprising:
one or more play items having one or more action sensors, said one or more action sensors detects said user's actions and further produces one or more actions signals;
a function control unit connected with said a virtual personal assistant software through input server, said function control unit comprising:
a generator operative for generating a frequency;
a convertor operative for converting the frequency into alternating electric field;
one or more sensors operative for detecting said one or more action signals; and
an interface operative to transmit said one or more action signals received from said one or more sensors to said virtual personal assistant software;
a personal assistant portal operative to process one or more action signals, said personal assistant portal comprising:
a user bank storage operative for storing details of said registered user;
a job bank storage operative for storing instructions of gaming; and
a virtual personal assistant software connected with said user bank and said job bank, said virtual personal assistant software operative to transmit information stored in said user bank and said job bank, said transmitted information played by said one or more feedback unit; and
such that said one or more play items form a closed electrical circuit with said one or more users under the influence of alternating electric field produced from said convertor; further such that said one or more feedback to play said processed one or more action signals and gaming instructions received from said personal assistant portal.

13. The one or more play items according to claim 12, further comprising one or more actors modules operative for electromechanical movements.

14. The one or more play items according to claim 12, to be controlled by said personal assistant portal.

15. The function control unit according to claim 12, further comprises a signal-to-function box operative for receiving said processed one or more action signals and transmitting function signals through alternating electric field to said one or more play items.

16. The interactive gaming system according to claim 12, wherein said virtual personal assistant software sends one or more commands to at least one of: said one or more feedback unit; or said function control unit or over the internet.

17. The user bank according to claim 12, further comprising a register page operative for allowing registration of users.

18. The job bank according to claim 12, further comprising an instruction page operative for entering either game related or user related or content related instructions.

19. The personal assistant portal according to claim 12, further includes a customer relationship management module operative to maintain the activities of said user.

20. The interactive gaming system according to claim 12, wherein said one or more play items placed on the touch screen of a computing device, said computing device operative to process said action signals released from said one or more play items, said processed action signals to be played on said one or more feedback unit.
